(19) United States
(12) Patent Application Publication
(10) Pub. No.: US 2013/0071051 A1
(43) Pub. Date: Mar. 21, 2013

(54) ASSEMBLY STRUCTURE

(71) Applicants: AN SZU HSU, NEW TAIPEI CITY (TW); WAY HAN DAI, NEW TAIPEI CITY (TW)

(72) Inventors: AN SZU HSU, NEW TAIPEI CITY (TW); WAY HAN DAI, NEW TAIPEI CITY (TW)

(73) Assignee: FIRST DOME CORPORATION, NEW TAIPEI CITY (TW)

(21) Appl. No.: 13/233,153

(22) Filed: Sep. 15, 2011

(51) Int. Cl. F16C 29/02

(52) U.S. Cl. 384/37

(57) ABSTRACT

An assembly structure includes a sliding element, a relative sliding element and an elastic element. The relative sliding element includes sliding-guided portions disposed at the two sides thereof, and the sliding element includes sliding jacket portions clamped to the two sliding-guided portions of the relative sliding element. The elastic element includes a coil winding portion formed with two ends, and a first swing arm and a second swing arm are respectively disposed on the two ends of the coil winding portion and respectively located in the vicinity of the sliding element and the relative sliding element. The first swing arm is pivoted to the relative sliding element, and the second swing arm is pivoted to the sliding element, so that the deformed portion of the coil winding portion limited by the first and second swing arms can be prevented from rubbing against the sliding element.

### BACKGROUND OF THE INVENTION

1. Field of the Invention

The present invention relates to an assembly structure, and in particular relates to an assembly structure capable of preventing a forcedly-deformed elastic element from rubbing against a sliding element in the sliding process.

2. Description of the Related Art

As shown in FIGS. 1 to 4, a conventional structure of two relative-sliding components mainly includes a relative sliding element 1, a sliding element 2 and an elastic element 4 (e.g., a wound spring). The relative sliding element 1 includes two sliding-guided portions 11 (e.g., guide rails) disposed at the two sides thereof and a support portion 12 disposed on a middle section thereof. The sliding element 2 includes two sliding jacket portion 21 disposed at two sides thereof and clamped to the two sliding-guided portions 11 (the guide rails) of the relative sliding element 1 and a support portion 22. The elastic element 4 includes a middle section, a coil winding portion 43 arranged at the middle section and providing two ends, and two outwardly protruded swing arms 41 and 42 disposed at the two ends of the coil winding portion 43, wherein the swing arm 42 is located at an upper side in the vicinity of the sliding element 2, and the swing arm 41 is located at a lower side in the vicinity of the relative sliding element 1. A hook portion 421 provided on an outer end of the swing arm 42 of the elastic element 4 is jacketed to the support portion 22 of the sliding element 2, and a hook portion 411 provided on an outer end of the swing arm 41 of the elastic element 4 is jacketed to the support portion 12 of the relative sliding element 1 (shown in FIGS. 1 and 2). The elastic element 4 is compressed to store energy therein or extended to release energy therefrom when the sliding element 2 is slid on the relative sliding element 1, enabling the sliding element 2 to automatically slide to the distal end when the sliding element 2 approaches the distal end in the sliding process (shown in FIG. 3).

However, when the elastic element 4 is compressed or extended in the sliding process above, a variable angle formed between the swing arms 41 and 42 forms the coil winding portion 43 to be axially and deformedly twisted and partially projected to the sliding path of the sliding element 2. Therefore, the sliding element 2 is frequently to be rubbed by the top of the coil winding portion 43 and the swing arm 42 and the relative sliding element 1 is also frequently rubbed by the bottom of the coil winding portion 43 and the swing arm 42 (shown in FIG. 4), resulting in the abrasions of the corresponding portions of the relative sliding element 1 and the sliding element 2 relative to the elastic element or even the stuck of the sliding element 2. Although the described problems can be solved by considering dimensional allocations of the relative sliding element 1, the sliding element 2 and the elastic element 4 into the design and taking the notice of the adjustments of the related assembly flatness, the assembling process is more complicated and the manufacturing cost is relatively increased.

### BRIEF SUMMARY OF THE INVENTION

In view of this, the present invention provides an assembly structure to overcome the disadvantages of the conventional relative sliding element structure provided with the wound elastic element.

The main purpose of the present invention is to provide an assembly structure, capable of limiting the deformation direction of a force-summing elastic element to avoid the undesired contacts and abrasions between a sliding element and the elastic element in the sliding process and increasing the sliding smoothness between the relative sliding element and the sliding element.

To attain the purposes and effects above, the technical way adopted by the present invention comprises a sliding element, a relative sliding element and an elastic element. The sliding element is slidably disposed on the relative sliding element. The elastic element, disposed between the relative sliding element and the sliding element and formed with a middle section, comprises a coil winding portion arranged at the middle section and formed with two ends, and a first swing arm and a second swing arm respectively disposed on the two ends of the coil winding portion and respectively located in the vicinity of the sliding element and the relative sliding element. The first swing arm of the elastic element includes an outer end pivoted to the relative sliding element, and the second swing arm of the elastic element includes an outer end pivoted to the sliding element.

According to the structure above, the relative sliding element includes sliding-guided portions disposed at the two sides thereof, and the sliding element includes sliding jacket portion corresponding to and clamped to the two sliding-guided portions of the relative sliding element.

According to the structure above, the sliding-guided portions of the relative sliding element are guide rails.

According to the structure above, the sliding element and the relative sliding element are respectively provided with a support portion, and the outer ends of the first swing arm and the second swing arm of the elastic element are respectively pivoted to the support portions of the relative sliding element and the support portion of the sliding element.

According to the structure above, each of the outer ends of the first swing arm and the second swing arm of the elastic element includes a hook portion, and the hook portions of the first swing arm and the second swing arm of the elastic element are jacketed to the support portions of the relative sliding element and the support portion of the sliding element.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is an exploded view showing a conventional relative sliding element structure provided with a wound elastic element;

FIG. 2 is an assembled view showing the conventional relative sliding element structure provided with the wound elastic element;

FIG. 3 is a schematic view showing the operation of the conventional relative sliding element structure provided with the wound elastic element;

FIG. 4 is a structural sectional view showing the conventional relative sliding element structure provided with the wound elastic element, wherein interference is occurred in the sliding process of the conventional relative sliding element structure;

FIG. 5 is a structural exploded view of the present invention;

FIG. 6 is an assembled outside view of the present invention;

FIG. 7 is view showing operation of the present invention; and

FIG. 8 is a structural sectional view showing that interference is prevented in the sliding process of the present invention.

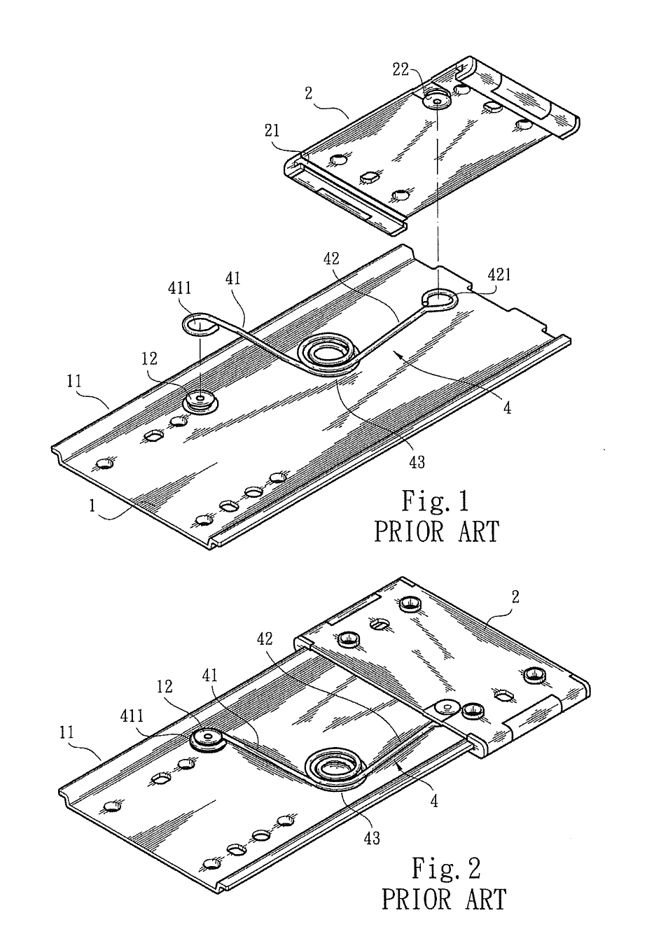

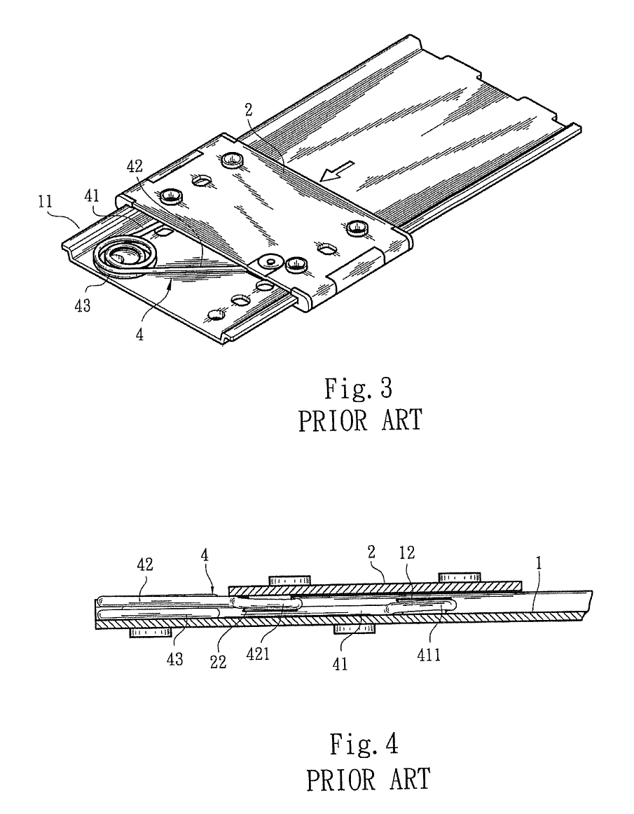

### DETAILED DESCRIPTION OF THE INVENTION

The following description is of the best-contemplated mode of carrying out the present invention. This description is made for the purpose of illustrating the general principles of the present invention and should not be taken in a limiting sense. The scope of the present invention is best determined by reference to the appended claims.

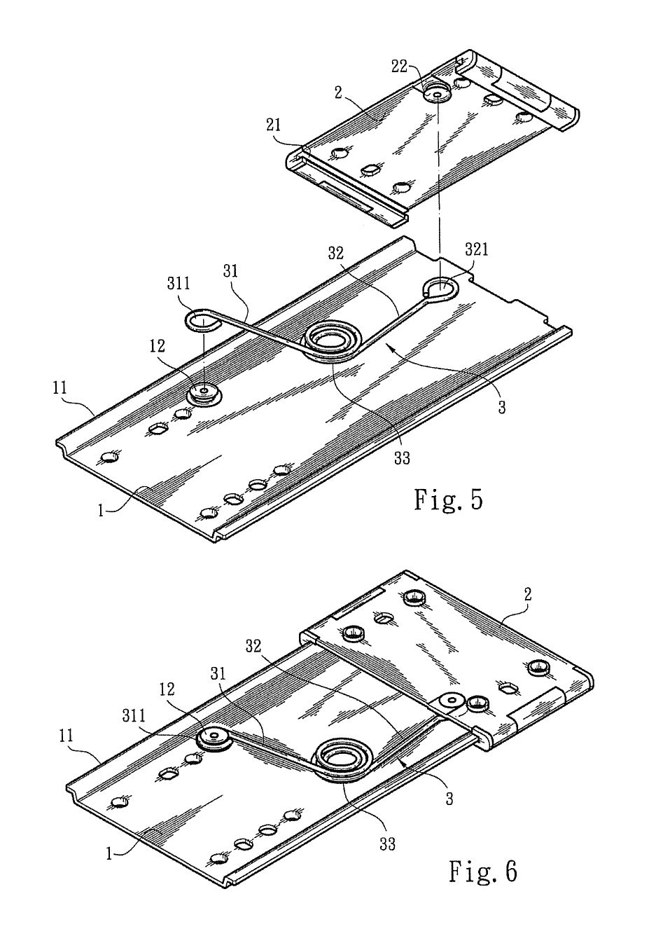

Referring to FIGS. 5 and 6, an assembly structure of the present invention mainly comprises a sliding element 2, a relative sliding element 1, and an elastic element 3 assembled between the relative sliding element 1 and the sliding element 2. The relative sliding element 1 includes two sliding-guided portions 11 disposed at the two sides thereof and a support portion 12 protrudedly disposed on a site close to a middle section thereof. In this embodiment, the sliding-guided portions 11 of the relative sliding element 1 are guide rails. The sliding element 2 slidably disposed on the relative sliding element 1 comprises two sliding jacket portion 21 corresponding to and clamped to the two sliding-guided portions 11 of the relative sliding element 1 and a support portion 22 corresponding to the support portion 12 of the relative sliding element 1, so that the sliding element 2 can slide along the two sliding-guided portions 11 (the guide rails) of the relative sliding element 1 relative to the relative sliding element 1. The elastic element 3 comprises a first swing arm 31, a second swing arm 32 and a coil winding portion 33 arranged at a middle section thereof, wherein the coil winding portion 33 is formed with two ends, the first swing arm 31 disposed on one end of the coil winding portion 33 in the vicinity of the sliding element 2 includes an outer end pivoted to the relative sliding element 1, and the second swing arm 32 disposed on the other end of the coil winding portion 33 in the vicinity of the relative sliding element 1 includes an outer end pivoted to the sliding element 2. The outer ends of the first swing arm 31 and the second swing arm 32 of the elastic element 3 are respectively pivoted to the support portion 12 of the relative sliding element 1 and the support portion 22 of the sliding element 2. The outer end of the first swing arm 31 of the elastic element includes a hook portion 311 jacketed to the support portion 12 of the relative sliding element 1, and the outer end of the second swing arm 32 of the elastic element includes a hook portion 321 jacketed to the support portion 22 of the sliding element 2, so that the first swing arm 31 and the second swing arm 32 can provide a relative clamping function at the two ends of the coil winding portion 33 to limitedly prevent the coil winding portion 33 from being axially, outwardly and protrudedly deformed.

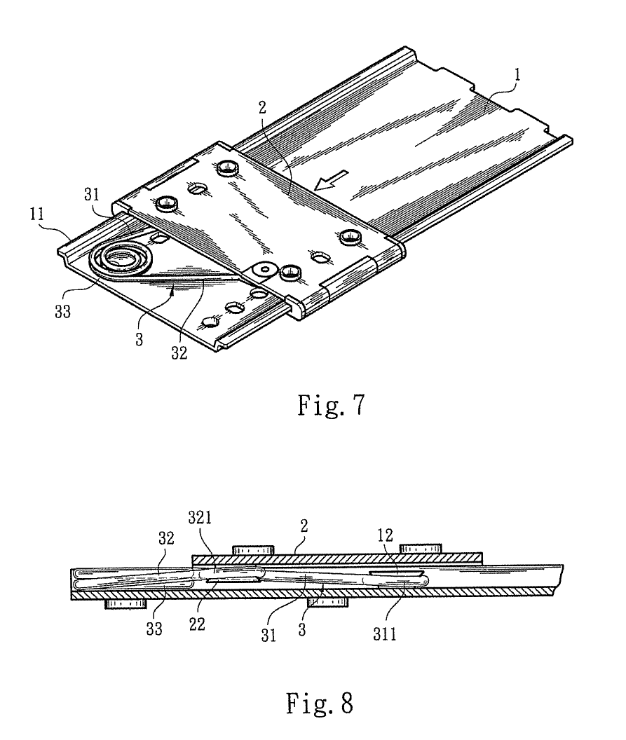

Referring to FIGS. 7 and 8, in the operation process of the present invention, the second swing arm 32 and the first swing arm 31 of the elastic element 3 linked by the relative sliding element 1 and the sliding element 2 are formed with a variable angle therebetween when the sliding element 2 is slid along the sliding-guided portions 11 (the guide rails) of the relative sliding element 1, so that the coil winding portion 33 of the elastic element 3 is deformed to store energy therein or release energy therefrom. Because the coil winding portion 33 of the elastic element 3, limited by the first and second swing arms 31 and 32 at the two ends thereof, is axially deformed and not protruded to the sliding path of the sliding element 2 in the deformation process, so that the coil winding portion 33 of the elastic element 3 does not rub against the sliding element 2 in the sliding process and the factors inferior to the sliding process of the sliding element 2 and the relative sliding element 1 can be eliminated.

In summary, the assembly structure of the invention can ensure that a forcedly-deformed elastic element can be prevented from rubbing against a sliding element, to increase the sliding smoothness in the sliding process. While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An assembly structure, at least comprising:
a sliding element;
a relative sliding element slidably disposed on the sliding element; and
an elastic element disposed between the sliding element and the relative sliding element and formed with a middle section, comprising a coil winding portion arranged at the middle section and formed with two ends, a first swing arm and a second swing arm respectively disposed on the two ends of the coil winding portion and respectively located in the vicinity of the sliding element and the relative sliding element, the first swing arm including an outer end pivoted to the relative sliding element, and the second swing arm including an outer end pivoted to the sliding element.

2. The assembly structure as claimed in claim 1, wherein the relative sliding element includes two sides and sliding-guided portions disposed at the two sides, and the sliding element includes sliding jacket portion corresponding to and clamped to the two sliding-guided portions of the relative sliding element.

3. The assembly structure as claimed in claim 2, wherein the sliding-guided portions of the relative sliding element are guide rails.

4. The assembly structure as claimed in claim 1, wherein the sliding element and the relative sliding element are respectively provided with a support portion, and the outer ends of the first swing arm and the second swing arm of the elastic element are respectively pivoted to the support portions of the relative sliding element and the support portion of the sliding element.

5. The assembly structure as claimed in claim 2, wherein the sliding element and the relative sliding element are respectively provided with a support portion, and the outer ends of the first swing arm and the second swing arm of the elastic element are respectively pivoted to the support portions of the relative sliding element and the support portion of the sliding element.

6. The assembly structure as claimed in claim 3, wherein the sliding element and the relative sliding element are respectively provided with a support portion, and the outer ends of the first swing arm and the second swing arm of the elastic element are respectively pivoted to the support portions of the relative sliding element and the support portion of the sliding element.

7. The assembly structure as claimed in claim 4, wherein each of the outer ends of the first swing arm and the second swing arm of the elastic element includes a hook portion, and the hook portions of the first swing arm and the second swing arm of the elastic element are jacketed to the support portions of the relative sliding element and the support portion of the sliding element.

8. The assembly structure as claimed in claim 5, wherein each of the outer ends of the first swing arm and the second swing arm of the elastic element includes a hook portion, and the hook portions of the first swing arm and the second swing arm of the elastic element are jacketed to the support portions of the relative sliding element and the support portion of the sliding element.

9. The assembly structure as claimed in claim 6, wherein each of the outer ends of the first swing arm and the second swing arm of the elastic element includes a hook portion, and the hook portions of the first swing arm and the second swing arm of the elastic element are jacketed to the support portions of the relative sliding element and the support portion of the sliding element.
